(19) United States
(12) Patent Application Publication
(10) Pub. No.: US 2007/0266092 A1
(43) Pub. Date: Nov. 15, 2007

(54) Conferencing system with automatic identification of speaker

(76) Inventor: Edmund O. Schweitzer III, Pullman, WA (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 11/431,232

(22) Filed: May 10, 2006

(51) Int. Cl. G06F 15/16

(52) U.S. Cl. 709/204

(57) ABSTRACT

A local speaker within a multi-group conference is identified on a remote display by displaying a representation of the speaker, which could be the speaker's image, name, or other identifying information, on a remote display. The speaker is identified by an identification mechanism, such as a bar code reader, coupled to the microphone assigned to the speaker. The speaker's identification information is transmitted from the local location to the remote location, where the speaker's representation is retrieved and displayed.

### FIELD OF THE INVENTION

The present invention relates generally to systems, methods and apparatus for providing conferencing services to groups of physically disparate participants, and more particularly to systems, methods, and apparatus for automatically identifying a speaker in a conference consisting of multiple groups of physically disparate participants.

### DESCRIPTION OF THE PRIOR ART

Conferencing systems have become an increasingly important business communication tool. These systems facilitate meetings between persons or groups of persons situated remotely from one another, thereby eliminating or substantially reducing the need for expensive and time-consuming business travel. For a conferencing system to work, two or more locations must be equipped to host a conference. Conferencing systems with and without video are both in widespread use.

A simple form of conferencing system is a speakerphone. Using a speakerphone, a set of participants situated at a particular location can converse with a different set of participants situated at a different location. However, the participants at the first location cannot see the participants at the second location. Therefore, a listener will not know who a particular speaker is unless the speaker identifies himself or the listener recognizes the speaker's voice.

Videoconferencing systems broadcast a video representation from one conferencing location to other conferencing locations. Therefore, participants at remote locations can see who is talking, and if the participants can visually recognize a speaker, they will be able to identify the speaker. In addition, videoconferencing allows sharing of visual information, such as photographs, charts and figures, and may be integrated with personal computer applications to allow for sophisticated multimedia presentations during a conference.

While videoconferencing systems have the advantages outlined above, they also have several disadvantages. For instance, videoconferencing systems are often difficult to configure and operate. A typical videoconferencing system may include a control unit connected to a variety of peripheral devices, such as a video camera, a video display monitor, one or more microphones, and one or more speakers. In addition, videoconferencing systems do not automatically identify the speaker. Therefore, if the listeners do not recognize the speaker, do not know the speaker's voice, or cannot see the speaker, the listeners will not know who the speaker is. Finally, videoconferencing systems must transmit video and audio data, and therefore require more bandwidth than a speakerphone.

Another example of conferencing technology is computer based conferencing systems, such as Microsoft's NetMeeting or WebEx. Computer based conferencing systems use a computer as a conferencing device. At a minimum, a conferencing computer is equipped with a microphone, and will often have a camera as well. The audio and video signals are digitized and transmitted using a network, such as the Internet, to other computers participating in the conference. The other computers then reconstruct the audio and video signals. In addition, computer based conferencing systems allow documents to be shared, and collaboratively modified by the meeting participants. However, unlike videoconferencing systems, where a single camera will capture a group of participants, computer based conferencing systems usually require each participant to have his or her own computer. Therefore, many different streams of audio and video data are constantly being acquired, each of which consumes network bandwidth. To limit the required network bandwidth, computer based conferencing systems usually allow users to designate which participants they wish to see, which limits the amount of network bandwidth required. However, by limiting who is visible, some of the utility of videoconferencing is lost. For instance, a user will not be able to identify who the speaker is unless the user is monitoring the speaker's video feed as well as the speaker's audio feed.

U.S. Pat. No. 5,273,437 (hereinafter, the '437 patent) discloses a different type of conferencing system. The '437 patent discloses an audience participation system, wherein an audience member can use a module to respond to a question posed by a speaker during a meeting or presentation. Each of the modules can be equipped with a bar code reader, which can read a badge identifying an audience member. When a particular audience member responds to a question, information about the audience member is collected as well and used in statistical analysis of the collected responses.

A type of speaker identification that is in wide use today is “caller ID,” which is used by the recipient of a telephone call to identify the caller. Certain phones, such as the V-Tech i5871, can display a picture associated with a particular telephone number. However, as many telephone numbers are used by multiple individuals the recipient of the call will not necessarily know the identity of the caller, but only the telephone number used to place the call.

### OBJECTS OF THE INVENTION

Accordingly, one object of the invention is to provide a conferencing system which clearly identifies the present speaker to all participants.

Another object of the invention is to provide a conferencing system that is simple to setup and operate.

Another object of the invention is to provide a caller identification system wherein the precise identity of a caller can be determined.

Another object of the invention is to provide an interactive conference hall, where audience members who pose questions to the presenter are clearly identified to the remainder of the audience.

### SUMMARY OF THE INVENTION

The present invention achieves its objects by identifying the user of a given microphone at a particular time. In one form of the invention, a local speaker in a multi-group conference is identified on a remote display by displaying a representation of the speaker, which could include his image, name, or other identifying information, on a remote display. The speaker is identified by an identification mechanism, such as a bar code reader or magnetic striper reader, associated with the microphone assigned to the speaker. In a preferred embodiment of this invention, the identification mechanism is disposed in the same housing as the microphone.

A further embodiment of the invention is includes the addition of a conferencing server, which receives identifying information from the identifying mechanism, and passes that identifying information to a remote conferencing server, thereby allowing the remote conferencing server to identify a speaker present at the local location.

Yet another embodiment of the invention is a method of displaying a previously stored representation of a speaker in a multi-group conference. Each conference will have at least one microphone, at least one identification mechanism, at least one display, and a conferencing server. Each local conferencing server will collect identifying indicia from each local identifying mechanism, and determine who the local participants are by searching a local database based on the collected identifying indicia. The local conferencing server then transmits a list of local participants to the remote conferencing servers, and receives a list of remote participants from the remote conferencing servers. During operation, the conferencing server receives signals from each participant's microphone, and determines if that participant is speaking by calculating the audible power of the participant's voice. If at least one individual is speaking, the local conferencing server compiles a list of local speakers, which it forwards to the remote conferencing servers. In return, the local conferencing server may receive one or more lists of speakers from the remote conferencing servers. The local conferencing server then compiles a master list of speakers, and sorts this list on audible power. The speaker with the highest audible power is displayed on at least one display controlled by the conferencing server.

Yet another embodiment of the invention is a digital telephone capable of displaying the identity of a caller. The digital telephone includes a handset including a microphone and a speaker, as well as a call placement mechanism. A network connection connected to a digital network, such as the Internet, is coupled to the handset. The network connection transmits and receives data and voice via the digital network. A card reader, which accepts identification cards, is also coupled to the network connection, and transmits identification information to any remote telephone. Memory within the phone stores representations of different individuals, and a processor coupled to the memory receives identification information from the network connection and retrieves the representation corresponding to the received identification information. The processor then displays the retrieved representation on an attached display.

Yet another embodiment of the disclosed invention is a conference hall presentation system. A roving audience participation device includes a microphone, an identification mechanism, and a wireless communication device. A conferencing computer is wirelessly coupled to the roving audience participation device, and receives identification information from an audience member using the roving audience participation device. The conferencing computer is also coupled to a display, where a retrieved representation of the audience member is displayed based on the received identification information.

### BRIEF DESCRIPTION OF THE DRAWINGS

Although the characteristic features of this invention will be particularly pointed out in the claims, the invention itself, and the manner in which it can be made and used, can be better understood by referring to the following description taken in connection with the accompanying drawings forming a part hereof, wherein like reference numerals refer to like parts throughout the several views and in which:

FIG. 1 illustrates a conference spanning two physically disparate locations using the disclosed invention.

FIG. 2 illustrates a microphone including an embedded identification device for use with the disclosed conferencing system.

FIG. 3 illustrates one possible layout of the display used by the disclosed conferencing system.

FIG. 4 depicts a block diagram of the microphone of FIG. 2.

FIG. 5 illustrates a conference spanning two physically disparate locations in accordance with the disclosed invention where each participant utilizes a notebook computer as a display device.

FIG. 6 depicts a notebook computer executing conferencing software in accordance with the disclosed invention.

FIG. 7A is a block diagram illustrating the major hardware components of a system implementing the disclosed invention.

FIG. 7B is a flow chart illustrating how identification information is collected locally and distributed to different remote sites.

FIG. 7C is a flow chart illustrating how the present invention determines the present speaker.

FIG. 8 shows a phone system utilizing the present invention to identify an individual placing a call.

FIG. 9 shows a conference hall utilizing the principles of the present invention, whereby a roving microphone with a card reader is used to identify audience members who pose questions to a presenter.

### DETAILED DESCRIPTION OF THE ILLUSTRATED EMBODIMENT

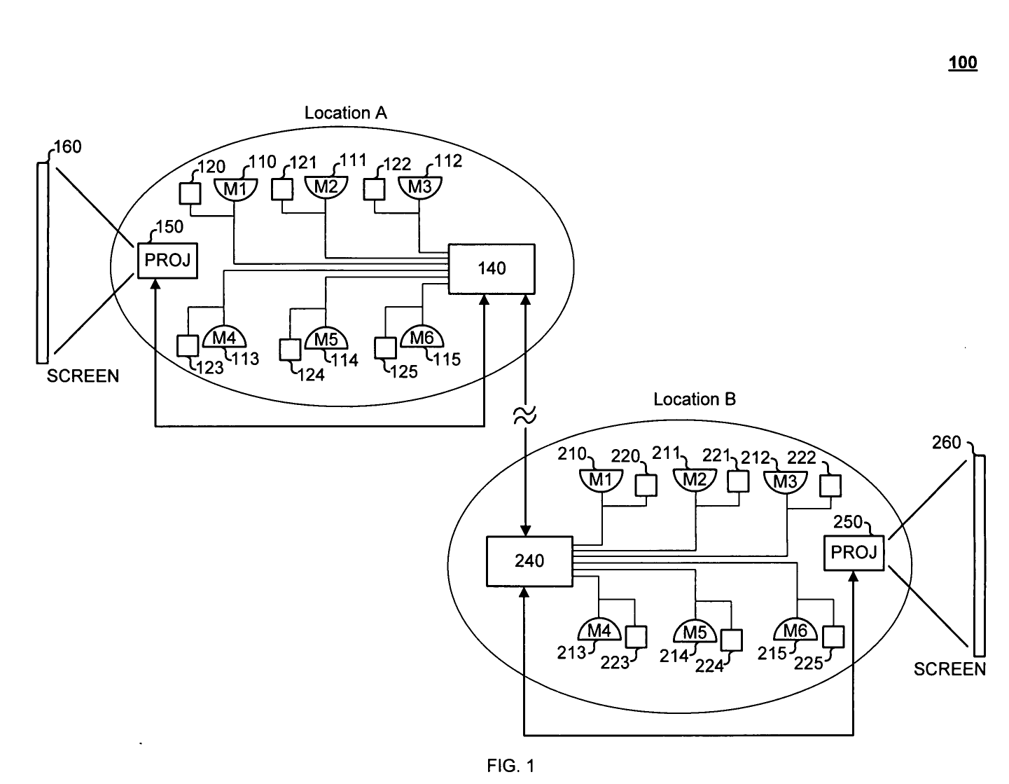

Referring to the drawings, and particularly to FIG. 1, a conferencing system 100 covering multiple disparate physical locations in accordance with the disclosed invention is shown. At each physical location, a number of microphones 110-115 are coupled to an equal number of identification devices 120-125. Each physical location is also equipped with a conferencing server 140, as well as a projector 150, and a screen 160. Conferencing server 140 is coupled to microphones 110-115 as well as identification devices 120-125. While FIG. 1 depicts a physical connection between the microphones 110-115, identification devices 120-125, and the conferencing server 140, wireless technology, such as Blue Tooth or 802.11, could be used. Wireless technology could also be used to connect the conferencing server 140 and the projector 150.

The conference participants (not shown) use the identification devices 120-125 to identify themselves before the conference begins. The identification devices 120-125 can be a manual input device, such as a keyboard, or an automated input device, such as a bar code reader, a magnetic stripe reader, a radio frequency identification (RFID) reader, a biometric reader, such as a retina scanner or fingerprint scanner, or a Wiegand reader. The identification devices 120-125 transmit the participants' identification information to the conferencing server 140. During the conference, the local conferencing server 140 executes software which identifies which if any of the local conference participants are speaking. The local conferencing server 140 also receives messages from the remote conferencing server 240, which indicate if any remote participant is speaking. If a conference participant is speaking, the local conferencing server 140 causes the projector 150 to display a representation of the speaking participant on the screen 160. Note that while the embodiment of FIG. 1 depicts a projector and screen, other types of display devices, such as a television, computer monitor, plasma screen, or liquid crystal display (LCD), could be used. Also note that a representation can be any indicator of the participant's identity, such as the participant's name, a brief biography, the participant's photograph, a combination of the above representations, or some other representation. Thereby every participant has basic information about the present speaker during a conference, even though the participants cannot necessarily see the speaker.

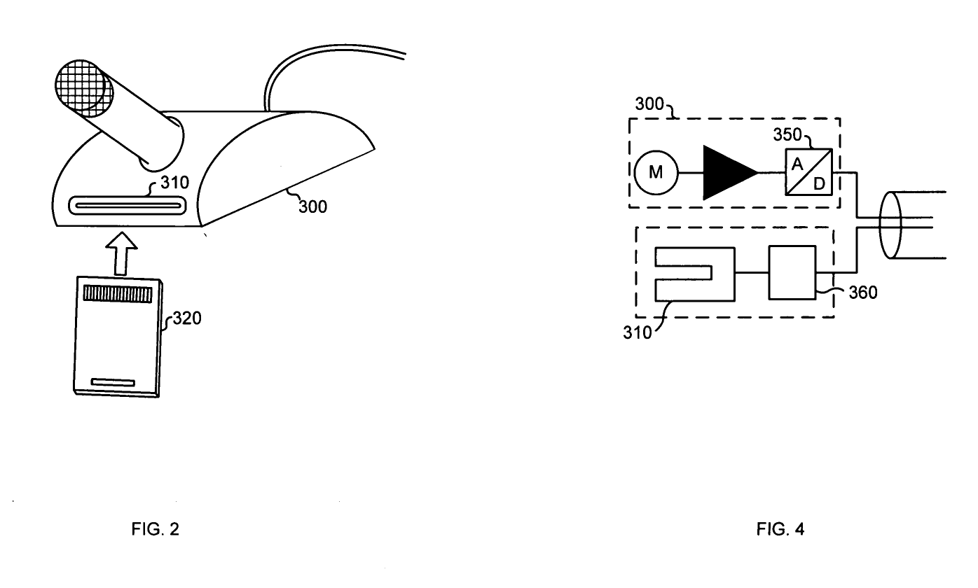

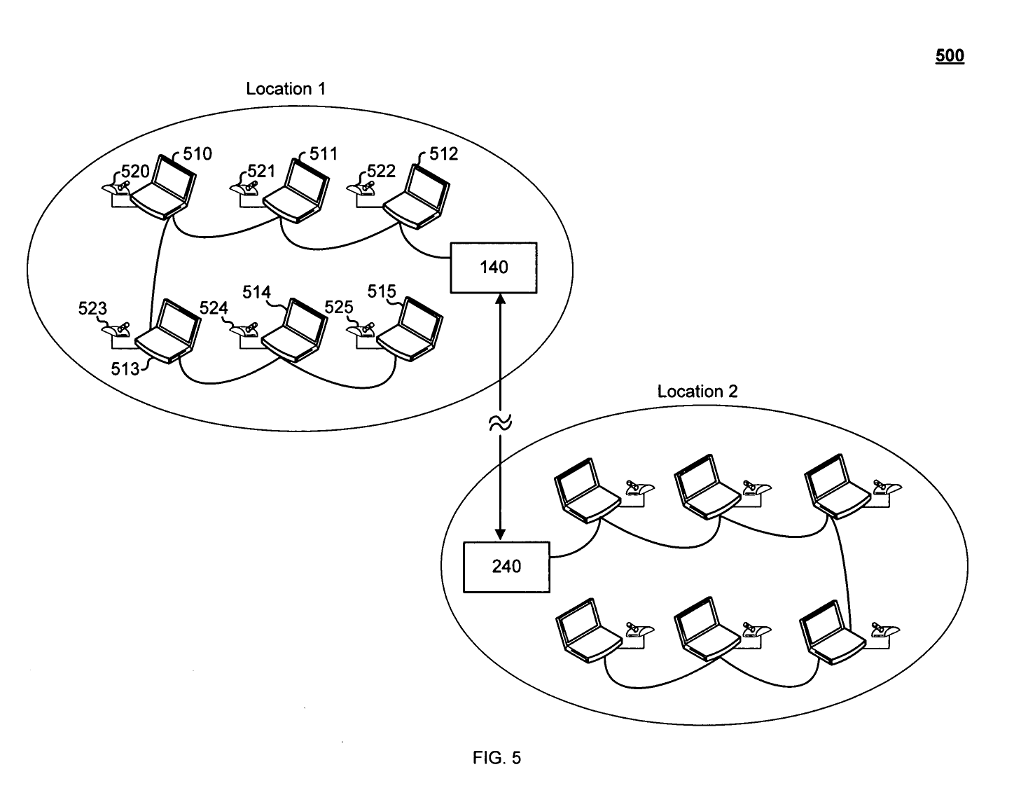

FIG. 2 shows a microphone 300 containing an embedded card reader 310. This microphone is especially adapted for use with the existing invention, as no additional identification device is required. The participant may insert his identification card 320 into the embedded card reader 310 to make his identification information available to the other participants. As depicted in FIG. 4, a storage block 360 may retain the individual's identity until the conference is terminated. The microphone 300 may then pass the participant's identification information to a local conferencing server (not shown) in digital form, which will associate the identified participant with the microphone 300. In one embodiment of the disclosed invention depicted in FIG. 4, the microphone 300 contains an analog to digital converter (ADC) 350, which samples the participant's voice at a sufficient rate, such as, for example, 9.6 kHz, to reproduce the user's voice at the remote location with sufficient quality. The microphone 300 will then transmit the samples to the conferencing server (not shown).

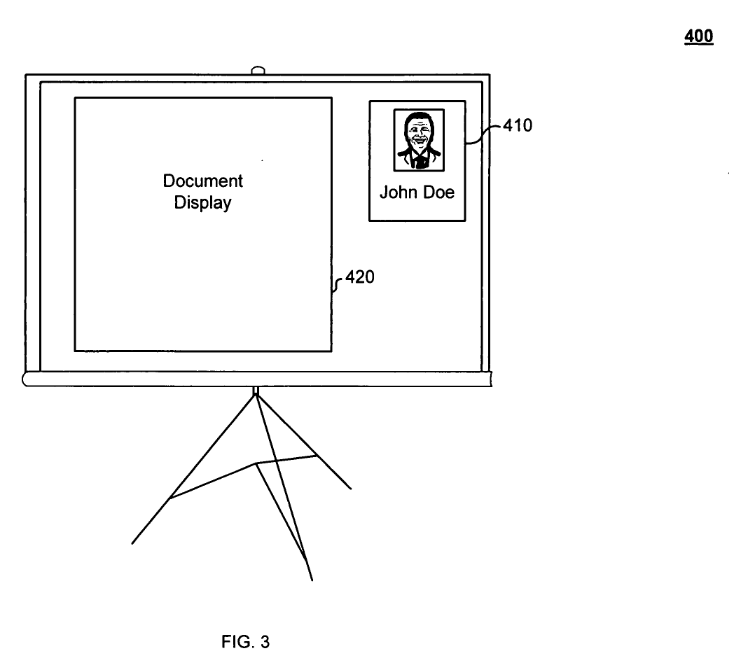

Referring to FIG. 3, one possible layout of the display utilized by the disclosed invention is shown. A liquid crystal display (LCD) 400 is mounted on a stand. In the upper right corner of the LCD 400 is a representation 410 of the present speaker. In this embodiment, the representation 410 of the present speaker includes the speaker's facial photograph, and the speaker's name. In addition, the LCD 400 also displays a document 420 discussed in the conference.

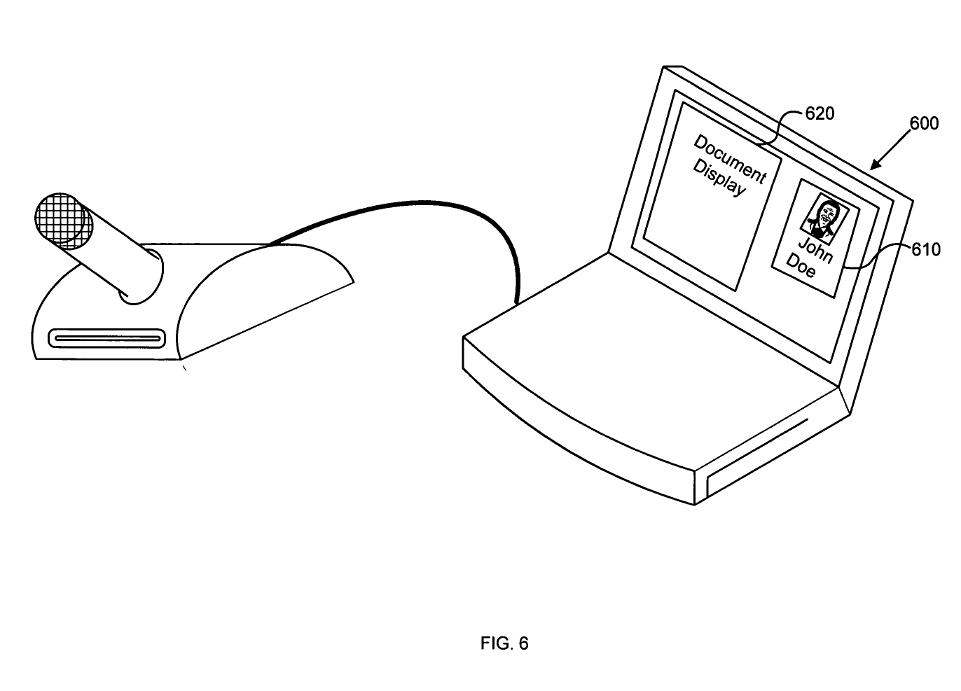

FIG. 5 depicts an alternate embodiment of the disclosed invention. In this embodiment notebook computers 510-515 are used instead of a separate display. As depicted, each notebook computer 510-515 is coupled to a microphone 520-525 similar to that depicted in FIG. 2, each of which is used to sample a particular participant's voice and to identify a particular participant. Alternatively, each notebook computer 510-515 could have an embedded microphone, and the participant's logon information could be used to identify the participant. In this embodiment, documents could be collaboratively modified by participants while working, and the identification system could be used to determine which participant was modifying a shared document.

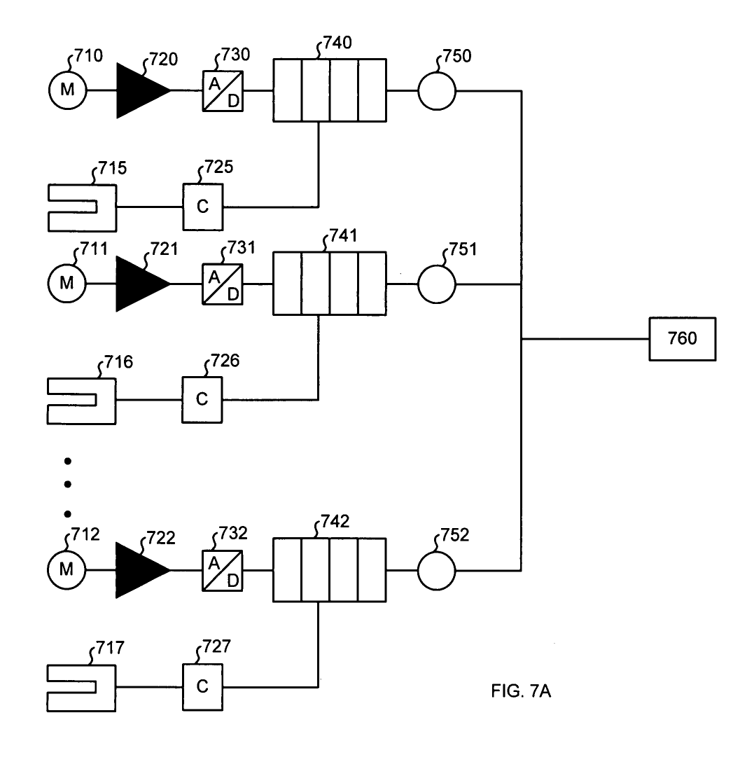

FIG. 6 depicts one possible layout of a notebook computer display 600 utilizing the disclosed invention. In the upper right corner of the notebook computer display 600 is a representation 610 of the present speaker. In this embodiment, the representation 610 of the present speaker is the speaker's facial photograph. In addition, the notebook computer display 600 also displays a document 620 discussed in the conference.

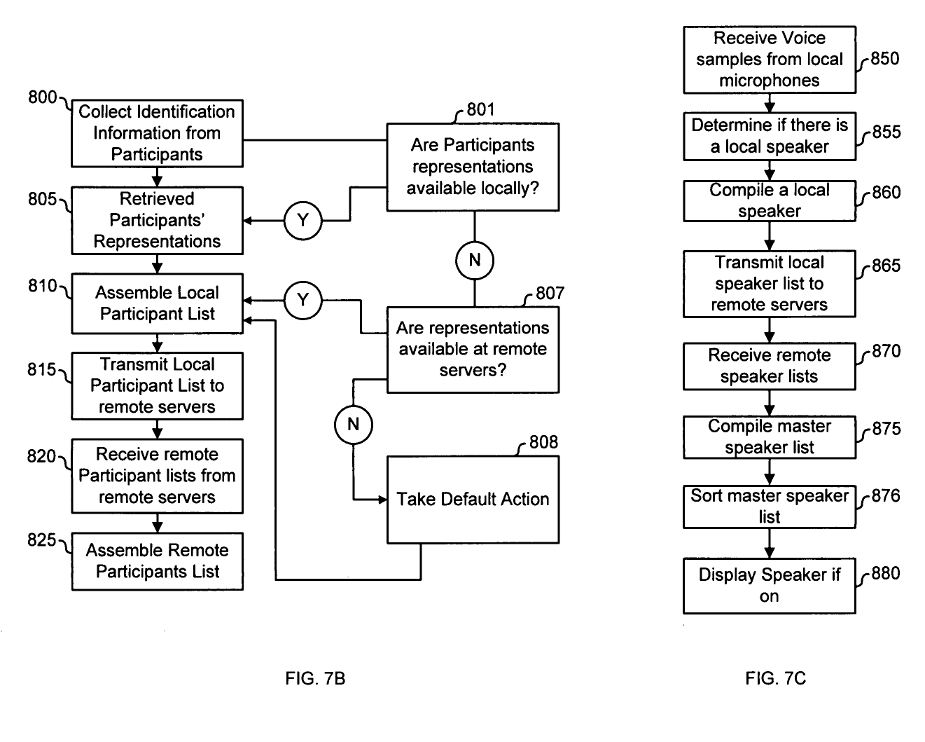

FIG. 7A is a block diagram showing the major components of a conferencing system implementing the disclosed invention. Card reader 715 accepts an ID card (not shown), which contains an indicia identifying the cardholder. The identifying indicia is converted to digital form by conversion block 725 and passed into buffer 740, where it is transmitted via network connection 750 to the local conferencing server 760. A microphone 710 converts a conference participant's voice into an electrical signal. The electrical signal is then passed through a signal conditioning block 720 and an ADC 730. The resultant digital samples are then passed into buffer 740, before being transmitted to the local conferencing server 760 via a network connection 750.

FIG. 7B illustrates how identification information for the conference participants is collected by a local conferencing server and disseminated to any remote conferencing servers. In step 800, the local conferencing server collects identification information from each microphone used in the conference. In step 801, the local conferencing server checks to see if the local participants' representations are stored on the conferencing server. If they are, then in step 805, the local conferencing server scans a database to ensure that it has access to a representation of all identified individuals. If no representation for a particular participant is found, the local conferencing server will request a representation from all remote conferencing servers in step 807. If no remote conferencing server has access to a representation for the particular participant, the local conferencing server can alert an operator to enter a representation for the particular participant, or can display a generic representation, such as “???” when the particular participant speaks, as reflected in step 808. In step 810, the local conference server assembles a local participant list. In step 815 the local conferencing server transmits a list of local participants to the remote conferencing servers, and in step 820, the local conferencing server receives a list of remote participants from the remote conferencing servers. Finally, in step 825, the local conferencing server assembles a complete participant list, holding each participant's representation in memory.

During operation, each conferencing server must determine which participant, if any, is speaking at a given time, and display that participant's image on a designated display. Referring to FIG. 7C, a local conferencing server receives samples from local microphones in step 850. In step 855, the received local samples are compared to a predetermined threshold power level to determine if there is a speaker. Any participants which are determined to be speaking are compiled into a local speaker list in step 860, which is forwarded to any remote conferencing servers in step 865. In step 870, the local conferencing server receives any remote speaker lists and compiles a master speaker list in step 875. The master speaker list is sorted by power level in step 876. The speaker, assuming there is one, with the highest audible power level is displayed in step 880. Alternatively, the audible signal strength of each speaker could be averaged for a predetermined period of time, and the present speaker could be determined by the speaker with the highest average audible signal strength for the predetermined period of time.

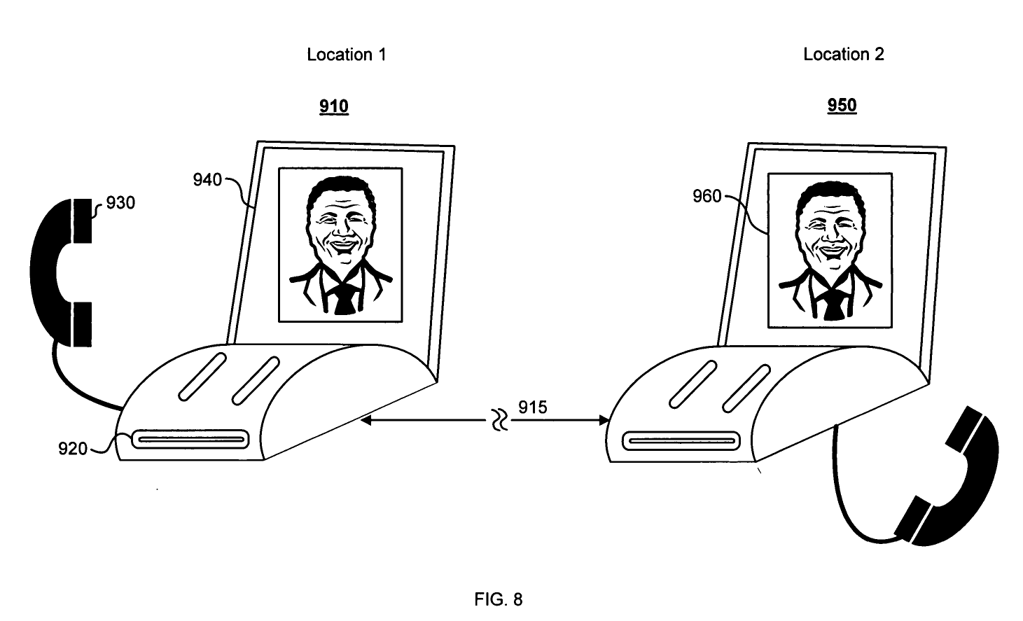

FIG. 8 shows an additional embodiment of the present invention. In this embodiment, a local digital telephone 910 contains an embedded card reader 920, a handset 930 including a microphone and a speaker, a call placement mechanism (not shown) and a display 940. Prior to placing a call, the caller places an identification card (not shown) into the card reader 920. The caller then uses a call placement mechanism (not shown) on the local digital telephone, which accesses the remote digital telephone 950 via a digital network connection 915. The remote digital telephone 950 will show a stored representation of the caller on its display 960. The displayed representation is determined by the identification card placed in the card reader 920 of the local digital telephone 910. This allows the party receiving the call to know precisely who is placing it, and not just what number it is being placed from.

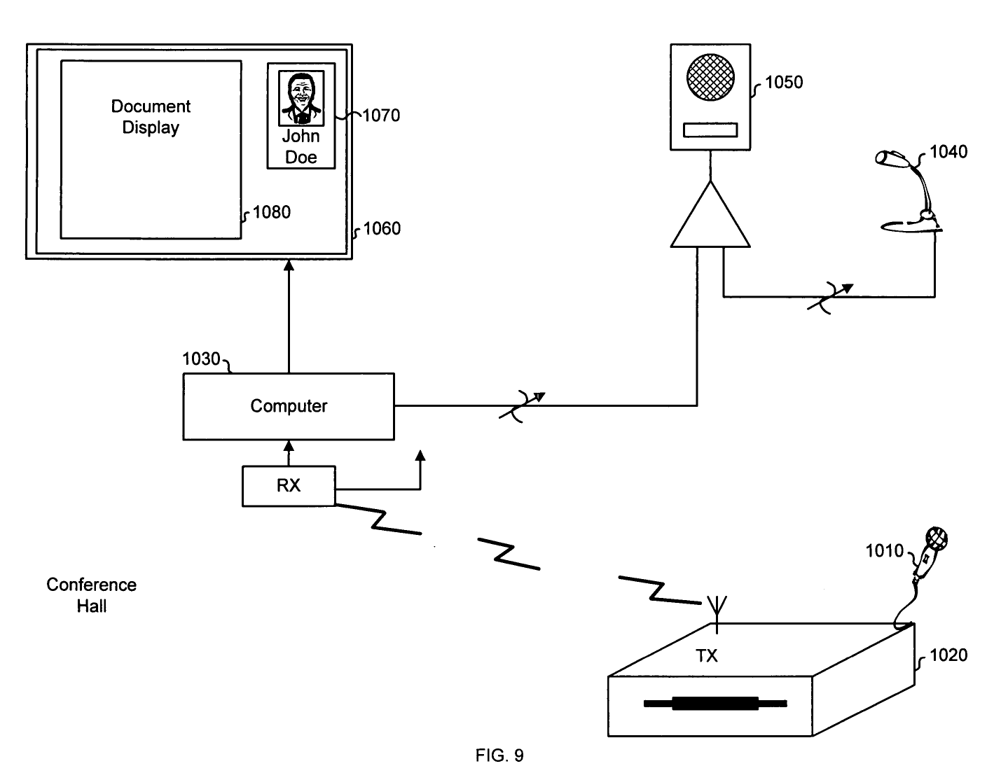

FIG. 9 shows another embodiment of the present invention. In this embodiment a roving microphone 1010 attached to a card reader 1020 wirelessly communicates with a conference computer 1030. A moderator also uses a microphone 1040. Both the conference computer 1030 and the moderator's microphone 1040 are connected to a conference hall audio system 1050. In addition, the conference computer 1030 is connected to a conference hall display 1060. In use, the roving microphone 1010 is passed to different members of the audience who may pose a question of the presenter. The audience member then inserts an ID card (not shown) into the card reader 1020, which wirelessly transmits his identification information to the conference computer 1030. The conference computer 1030 then retrieves a stored representation of the audience member and displays it on the conference hall display 1060. As depicted, the conference hall display 1060 displays a photograph of the audience member 1070 as well as a document under discussion 1080.

The foregoing description of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and various modifications as are suited to the particular use contemplated. It is intended that the scope of the invention not be limited by the specification, but be defined by the claims set forth below.

I claim:

1. A system for conferencing a first group of participants disposed at a first location with a second group of participants disposed at a second location, the system comprising:
i) at least one microphone disposed at the first location, the at least one microphone adapted to be operated by a particular operator disposed at the first location;
ii) at least one identification mechanism coupled to the at least one microphone; and
iii) a display disposed at the second location, the display operatively coupled to the at least one microphone, the display displaying a previously stored representation of the operator of the at least one microphone when the operator speaks into the microphone.

2. The system of claim 1 wherein the identification mechanism is incorporated into the microphone.

3. The system of claim 1, wherein the at least one identification mechanism is a bar code reader.

4. The system of claim 1, further comprising:
i) a first conferencing server disposed at the first location, the first conferencing server coupled to the at least one identification mechanism and coupled to the at least one microphone, the first conferencing server receiving an indicia representing the operator of the at least one microphone from the at least one identifying mechanism; and
ii) a second conferencing server disposed at the second location, the second conferencing server coupled to the display, the second conferencing server also operatively coupled to the first conferencing server, the second conferencing server receiving the indicia representing the operator of the at least one microphone from the first conferencing server, the second conferencing server causing the representation of the operator corresponding to the indicia to be displayed on the display.

5. The system of claim 4, wherein the indicia comprises a digitized image of the operator of the at least one microphone.

6. The system of claim 4, wherein said indicia is a digital identifier corresponding to the operator of the at least one microphone.

7. A method of displaying a previously stored representation of a present speaker in a multi-group conference, wherein each group is comprised of multiple participants, wherein there is a local group and at least one remote group, and wherein there is a local conferencing server, at least one local display, at least one local microphone, and at least one local identification mechanism, and wherein there is at least one remote conferencing server, the method operating within the local conferencing server and comprising the steps of:
i) collecting an identification indicia from the at least one local identification mechanism, each identification indicia corresponding to an individual participant;
ii) retrieving a representation corresponding to each collected identification indicia;
iii) transmitting a list of local participants to the at least one remote conferencing server;
iv) receiving at least one list of remote participants from the at least one remote conferencing server;
v) determining if there is at least one local speaker by comparing the audible signal strength of the at least one local microphone to a predetermined threshold;
vi) transmitting the identity and audible signal strength of the at least one local speaker, if said at least one local speaker was found to exist, to the at least one remote conferencing server;
vii) receiving the audible signal strength and identity of any remote speakers, from the at least one remote conferencing server;
viii) compiling a master speaker list of all local and remote speakers;
ix) determining the present speaker by sorting the master speaker list by audible signal strength; and
x) displaying a representation of the present speaker on the at least one local display.

8. The method of claim 7, further comprising the step of averaging the audible signal strength of each speaker for a predetermined period of time, and determining the present speaker based on the average audible signal strength for the predetermined period of time.

9. A digital telephone capable of displaying the identity of the caller comprising:
i) a handset including a microphone and a speaker;
ii) a call placement mechanism;
iii) a network connection for connecting to a digital network and capable of transmitting and receiving voice and data, the network connection responsive to the call placement mechanism, the telephone network connection also coupled to the handset;
iv) a card reader for reading identification cards, the card reader coupled to the network connection;
v) a processor, coupled to the network connection;
vi) memory for storing representations of different individuals, the memory coupled to the processor; and
vii) a display, coupled to the processor, wherein the processor receives identification information from the network connection regarding the individual who placed an incoming call, and wherein the processor retrieves the representation of the calling individual from the memory and displays it on the display.

10. A conference hall presentation system comprising:
i) a roving audience participation device, the roving audience participation device including an identification mechanism for receiving identification information from an audience member, a microphone, and a wireless communication device;
ii) a display; and
iii) a conference computer operatively coupled to the roving audience participation device, the conference computer also coupled to the display, wherein the conference computer retrieves a representation corresponding to identification information received from the roving audience participation device and displays the representation on the display.
